(19) United States
(12) Patent Application Publication
(10) Pub. No.: US 2012/0212943 A1
(43) Pub. Date: Aug. 23, 2012

(54) Lighting fixture

(76) Inventor: Jeffrey W. Stoltz, Woodstock, IL (US)

(21) Appl. No.: 13/385,331

(22) Filed: Feb. 14, 2012

Related U.S. Application Data
(60) Provisional application No. 61/463,480, filed on Feb. 17, 2011.

(51) Int. Cl. F21L 4/02; F21V 21/08; F21V 21/00

(52) U.S. Cl. 362/183; 362/185; 362/217.1; 362/217.12

(57) ABSTRACT

A lighting fixture comprises a cylindrical or U-shaped sleeve configured to engage a shower curtain rod or other support. The fixture contains a plurality of low-voltage lighting elements wired to a common power supply, enabling a user to safely retrofit lights into a bath or shower area.

### CROSS REFERENCE TO RELATED APPLICATION

This application claims the benefit of Provisional Application Ser. No. 61/463,480 entitled, “Lighting Fixture”, filed by the present inventor on Feb. 17, 2011, the entire disclosure of which is incorporated herein by reference.

### BACKGROUND OF THE INVENTION

1. Field of the Invention

The invention pertains to apparatus and methods for providing supplemental lighting to selected areas, and more particularly to a lighting fixture that can be attached to an existing curtain rod or shower door.

2. Description of Related Art

In many older homes, the bathroom contains a shower/bath area that has no lighting fixture therein, and without a dedicated light the user often finds the available room light to be insufficient once the shower curtains are closed. To retrofit the shower/bath area with a standard 110-V light fixture can become an expensive and time consuming task, usually requiring a qualified craftsman and/or contractor. Typically, holes have to be cut into the walls or ceiling of the shower/bath area and if the existing surfaces are covered with ceramic tile it is an even more difficult job. Tile can be hard to match and much dust and debris is generated. Furthermore, precautions must be taken to ensure that the fixture is waterproof and all wiring is arranged to avoid the possibility of electric shock to the user.

An illuminated shower hook, disclosed by Chien in U.S. Pat. No. 7,818,827, contemplates incorporating a lighting device such as an LED, and a power source such as a battery, into a hook that supports a shower curtain. It will be appreciated that if a user replaces a large number of curtain hooks with such devices, there is a large number of redundant components, adding to the overall cost and complexity. For example, each of the curtain hook/lighting elements must be turned off and on individually, large numbers of small batteries will need to be replaced regularly, etc. Furthermore, the amount of light that could be provided by such devices would be severely limited by the necessarily small size of a battery that can be fit into the hook assembly.

What is needed, therefore, is a simple system for retrofitting a lighting fixture to a bathroom shower, that is capable of providing a significant amount of light, without the need to replace numerous small batteries frequently.

### OBJECTS AND ADVANTAGES

Objects of the present invention include the following: providing a low-cost lighting fixture adapted to be fit over a shower curtain rod; providing an energy-efficient lighting fixture for a bathroom; providing a low-voltage lighting fixture for a shower area; and, providing a method for retrofitting a lighting fixture to a shower area that requires no special tools or training. These and other objects and advantages of the invention will become apparent from consideration of the following specification, read in conjunction with the drawings.

### SUMMARY OF THE INVENTION

According to one aspect of the invention, a lighting fixture comprises:

a generally elongated structural member adapted to grasp a support; and,

a circuit including a plurality of lighting elements disposed at selected points along the length of the interior of the structural member and connected to a common power source controllable by means of a switch.

According to another aspect of the invention, a lighting fixture comprises:

a generally elongated flexible circuit having a plurality of lighting elements mounted at selected places along its length;

a generally cylindrical structural member whose inner diameter is large enough to accommodate a shower curtain rod therein;

a plurality of windows in the structural member positioned along its length to align with the lighting elements;

a power supply sufficient to energize the lighting elements for a selected duty cycle; and,

a switch to turn the lighting elements on and off.

According to another aspect of the invention, a lighting fixture comprises:

a water-resistant housing, at least a portion of which is transmissive to light, the housing further including a bracket to hang the housing in a shower facility;

a plurality of lighting elements disposed within the waterproof housing;

a power supply disposed within the waterproof housing for supplying power to the lighting elements; and,

a switch for controlling the power supply.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one example of the present invention, in which a structural member, containing a lighting circuit, is configured to grasp a rod-shaped support.

FIG. 2 is a schematic diagram of another example of the present invention.

FIG. 3 illustrates another example of the present invention, in which a structural member, containing a lighting circuit is configured to grasp a generally rectangular support.

FIG. 4 illustrates one example of the use of the invention to provide lighting in a shower area.

FIG. 5 illustrates an example of the invention in which a modular design allows the lighting fixture to be lengthened or shortened to fit a particular space.

FIG. 6 illustrates an example of the invention configured to hang from a support rather than completely surrounding the support.

### DETAILED DESCRIPTION OF THE INVENTION

In general terms, the invention provides a low cost means to light a consumer shower area that currently has no light. It allows the homeowner to easily retrofit the shower/bath area with a light fixture that is safe and reliable. The fixture comprises a cylindrical structural member of an appropriate size and shape to slide over an existing curtain rod like a sleeve, or to engage various other supporting structures. As will be shown in the examples to follow, there are many suitable ways to configure the mechanical engagement between the structural member and the curtain rod or other support. The structural member, in turn, supports an internal electrical circuit running generally along its length, the circuit containing, at a minimum, a plurality of lighting elements, a power supply, and a switch. The structural member further contains openings (or alternatively, transparent regions) aligned with the lighting elements so that the light may emerge. In one example, the fixture is installed as follows: First, the curtain and curtain rings are removed from the curtain rod; second, the structural member is spread open and then closed around the curtain rod; third, the fixture is rotated so that the lighting elements are turned in the desired direction and, optionally, clamped securely in the selected position; fourth, the shower hooks and curtain are hung around the fixture.

The following examples will illustrate various aspects of the invention, and are not intended to limit the scope of the invention to any particular designs or configurations.

### Example

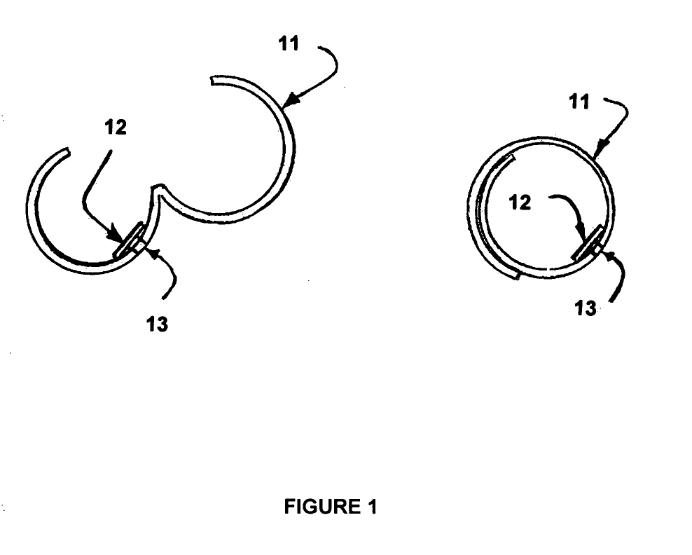

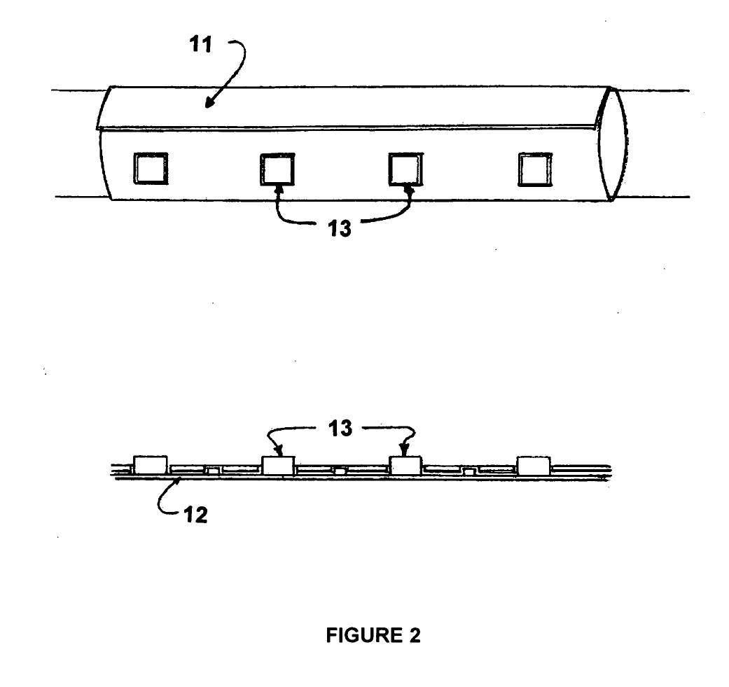

FIG. 1 illustrates a schematic diagram of one example of the invention, shown in end view, in which a cylindrical structural member 11 contains an electrical circuit (preferably a flex circuit) 12 running along its length. Lighting elements 13 are positioned at selected points along the length of circuit 12. A power supply and switch (not shown) allow the lighting elements 13 to be turned off and on by a user. FIG. 2 illustrates a side view of one example of the invention.

### Example

Structural member 11 may be constructed out of a flexible polymeric material such as 0.020″ vinyl that is formed to wrap around the outside diameter of a shower curtain rod like a sleeve, and flexible enough so that it may be spread open elastically and snapped around the curtain rod. Alternatively, if the sleeve is made from a thicker or more rigid material, it may be hinged in such a way that it can be opened and then closed about the curtain rod and held in place with a snap ring on each end or various other mechanical means as are well known in the art.
The sleeve 11 may be formed in various sizes to correspond to standard building practices, such as the conventional use of shower curtain rods that are 5 feet long and 1 inch diameter. Depending on the application, the sleeve 11 may wrap completely around the supporting rod, with or without some overlap as shown generally in FIG. 1, or it may be sufficiently rigid to hold its position while only wrapping around part of the circumference of the supporting rod.

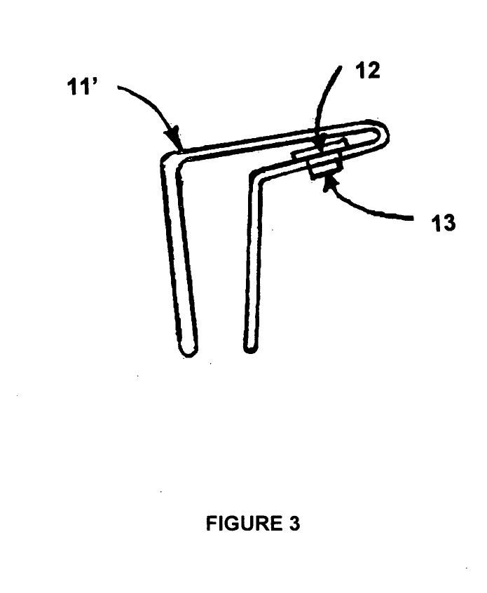

It will be appreciated that a thicker sleeve will allow more space for the individual lighting elements and provide some protection from inadvertent mechanical damage. Although the structural member in the foregoing example is generally cylindrical in shape, to be placed around a curtain rod, it will be appreciated that the structural member may also be generally U-shaped, as shown schematically in FIG. 3, to enable it to be slipped onto the top of a shower door, for example. Such a form factor could also be used to fit the lighting fixture to the top edge of a cabinet, for instance. It will be appreciated that the structural member 11′ may be extruded, or it may be formed from a flat sheet that is cut to size, punched (for the openings for lighting devices), and then folded together after the electrical circuit is attached to the inner surface. The structure shown in FIG. 3 may alternatively be fabricated from two generally L-shaped structural components, one of which has openings for the lighting devices; in this case, circuit 12 would be bonded to the first L-shaped member, and then the second L-shaped member would be bonded to the first, preferably by adhesive bonding.

It will further be appreciated that the structural member 11, 11′ may be any material having suitable mechanical properties, viz., adequate structural rigidity to remain in position once placed in service, along with sufficient flexibility to be snapped or clipped into position during installation. It may be any of various structural polymers, metal alloys, etc. and may be formed by any suitable process such as extrusion, rolling, stamping, etc. It may be any desired color, or may be transparent or substantially colorless.

### Example

In the structural member or sleeve 11 a series of cut-out openings or windows are made, which align with the lighting elements 13. These cut-outs are preferably in a straight line and the number of cut-outs can vary. The purpose of these cut-outs is for a light-emitting diode (LED) or other small form factor light source to protrude or emit light through. The number of cut-outs corresponds to the number of lights in the strip. In a typical strip there might be 15 cut-outs on 3 inch centers. However, some units might have more or fewer lights and the centerline distance between cut-outs could vary.

### Example

A lighting fixture was constructed as follows: The lighting elements 13 comprised 15 surface mount LEDs and their size is 5050. They emit 5,000 lumens of white light and draw 60 mA each. They are assembled to a flexible circuit, which also contains resistors and a control integrated circuit (IC). On top of the flex circuit is a double sided adhesive layer that has cut-outs spaced to accommodate the resistors and LEDs (see FIG. 2). The adhesive layer is preferably at least as thick as the resistors so the cut-outs form a protective cavity around the resistors. The topside of the adhesive layer allows for attachment to the sleeve. It is joined to the sleeve so that the LEDs align with the cut-outs, the sleeve cut-outs thus forming a protective cavity around the LEDs. It will be appreciated that it is desirable to avoid protrusions on the upper surface of the fixture, so that the curtain rings may pass smoothly over it when the curtains are being drawn open or closed. Applicants contemplate that in general, the lighting elements will be directed somewhat downwardly into the shower area; thus, even if they protrude a slight distance from the structural support, they will not interfere with the movement of the curtain rings.

Although the preceding example employed surface mount LEDs, It will be appreciated that leaded LEDs could also be used and further that the circuit could be made using printed circuit board(s) (PCB or PWB) or wires. It will be further appreciated that various polymer adhesives, sealants, and potting compounds may be used, as are well known in the art, to make various parts of the invention waterproof, because many contemplated applications would be in shower/bath areas where water splashes, high humidity, and condensation are likely to be present.

### Example

The light strip circuit extends approximately six inches past the end of the sleeve (see FIG. 2). This end is terminated with a connector. The connector joins the light circuit to a power supply. One suitable power supply is a battery pack containing 4 D-size batteries. The battery pack is enclosed (so that the batteries are not exposed) and the batteries are wired in series. The battery pack has an on/off switch. It will be appreciated that a timed on/off switch or other power-saving strategies may also be used as well. The light strip circuit could be designed to connect to a hardwired power outlet by changing the controlling IC and connector and/or by adapting the circuit to operate from a conventional DC power supply operating according to various well known industry standards for low-voltage DC service. The battery pack has a hook to attach to the shower curtain. The example described herein is designed to burn about 50 hours with 4 D-size batteries, each with 12,000 mA·h capacity. It will be appreciated that various other primary, secondary, or rechargeable battery power sources such as lead-acid, lithium, nickel-cadmium, and nickel-metal hydride could also be used.

It will be appreciated that the invention provides a useful level of illumination (as opposed to simply a decorative effect as taught by Chien in U.S. Pat. No. 7,818,827) and furthermore offers significant advantages in terms of cost and convenience. Given the size and form factor shown in '827, the battery would be a so-called coin or button cell. Batteries of this type, which are well known in the art, and of a size appropriate for use as shown by Chien, have a capacity ranging from about 20-100 mA·h. Even with 2 batteries per shower hook, that would imply a total capacity of 40-200 mA·h. To achieve illumination comparable to that of the present invention, (using 60 mA LEDs), the battery life would range from perhaps 40 minutes to around 3 hours, and then all the batteries would have to be replaced at a cost of $30 to $90.

### Example

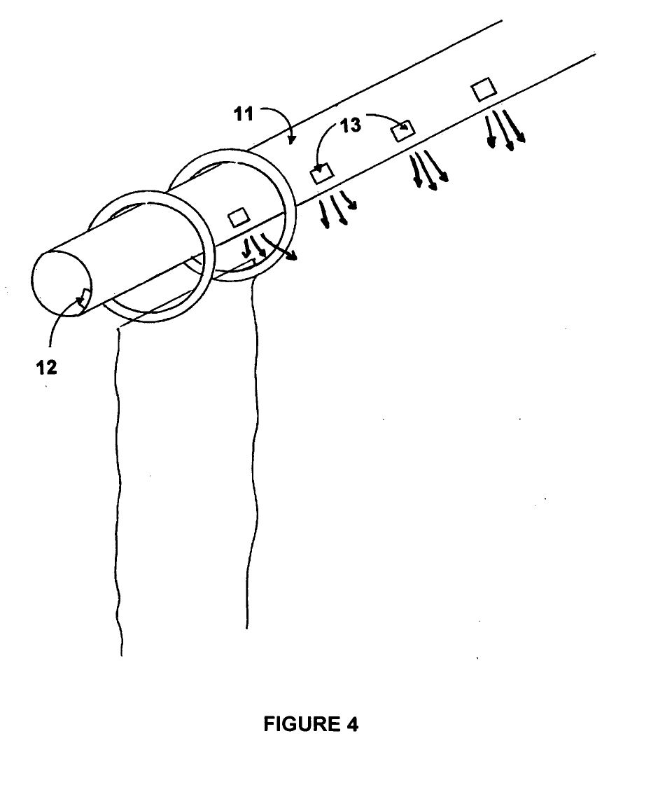

Installation of the fixture may be described as follows: One first removes the shower curtain and hangers. By spreading the sleeve apart slightly it will wrap around the shower curtain rod. The line of lights will then be angled towards the tub (typically at about 10-15° from the bottom center (see FIG. 4). This will allow the hangers to go back on and freely slide along the sleeved curtain rod and not interfere with the lights should they protrude from the sleeve.

Applicants contemplate that the individual lighting elements are preferably wired in parallel. This provides two important advantages. First, if one device fails, creating an open circuit, the remaining devices will continue to operate. More importantly, this allows the device to be simply cut to length if needed to accommodate a shorter space.

### Example

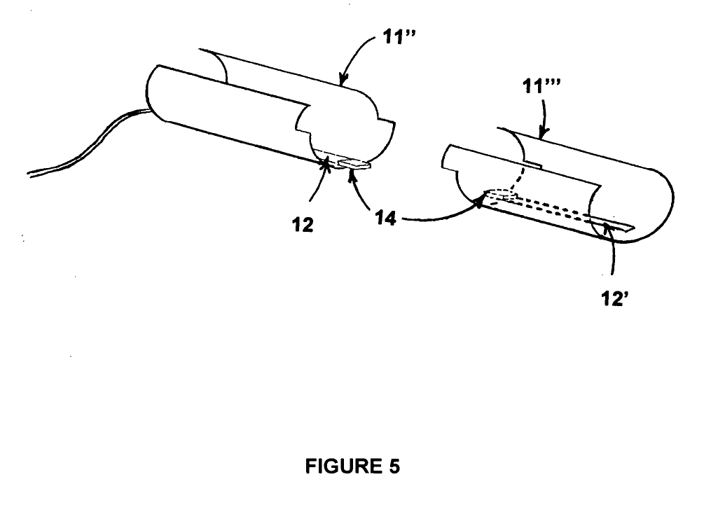

FIG. 5 illustrates an example of the invention in which individual modules are configured to snap together to expand the lighting fixture to any desired length. In this case, one module 11″ has a connection to the power supply, whereas subsequent modules 11′″ (one of which is shown) engage with one another via connector system 14. The user can therefore make a fixture of any desired length by snapping together the desired number of modules.

Although the examples illustrated structural member 11 as having a cut edge running generally lengthwise, it will be appreciated that it may be cut in a generally spiral fashion. In this case, the electrical circuit 12 would be attached parallel to the spiral and the lighting devices 13 may be spaced such that when the sleeve 11 is wrapped around a support, all the lighting devices will lie in a line generally parallel to the axis of the support.

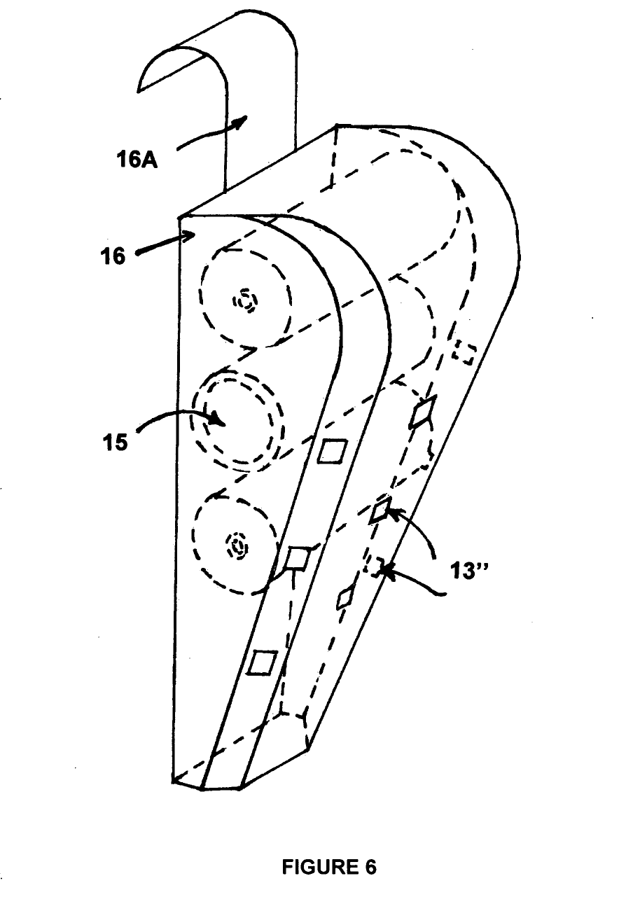

It will be appreciated that in some cases it may be desired to have a more concentrated lighting unit suitable for the bath or shower, which still preserves the benefits of other aspects of the invention already described. In this case, the invention may be modified as shown schematically in FIG. 6.

### Example

As illustrated in FIG. 6, the mounting sleeve 11 of the previous examples is modified to form a bracket 16A that is in turn a part of a generally waterproof housing 16. A power supply (preferably batteries 15) and lighting elements 13″ are contained within the housing 16. Using the integral bracket, the unit may be hung from a shower curtain rod, shower door, or from the shower head itself.

It will be appreciated that the configuration described in the foregoing example may be implemented in various ways. For instance, housing 16 may be generally opaque with transparent or translucent windows or apertures adjacent to individual lighting elements contained therein. Alternatively, housing 16 may be generally transparent or translucent and a strand of lights may be disposed in a generally random arrangement within the unit. When a translucent housing is desired, the housing may be formed of a translucent polymer or it may be formed of a transparent polymer having a light-scattering surface finish, the finish being created by abrasive blasting, casting, machining, or any other suitable means.

Although some of the foregoing examples are directed to the use of the invention in a shower or bath, it will be appreciated that the invention may also be used to provide light in closets, basements, outbuildings, and storage areas that are not wired for lighting

I claim:

1. A lighting fixture comprising:
a generally elongated structural member adapted to grasp a support, wherein at least a portion of said structural member is transmissive to light; and,
a circuit including a plurality of lighting elements disposed at selected points along the length of the interior of said structural member and connected to a common power source controllable by means of a switch.

2. The lighting fixture of claim 1 wherein said generally elongated structural member comprises a tube having a slit running from one end to the other so that said member may be slipped over and grasp a shower curtain rod.

3. The lighting fixture of claim 1 wherein said generally elongated tubular member comprises a generally U-shaped portion so that said member may be slipped over and grasp a straight edge of a shower enclosure.

4. The lighting fixture of claim 1 wherein said structural member comprises a material selected from the group consisting of: structural polymers and metal alloys.

5. The lighting fixture of claim 1 wherein said light-transmissive portion of said structural member comprises a plurality of openings in said member.

6. The lighting fixture of claim 1 wherein said lighting elements comprise light emitting diodes.

7. A lighting fixture comprising:
a generally elongated flexible circuit having a plurality of lighting elements mounted at selected places along its length;
a generally cylindrical structural member whose inner diameter is large enough to accommodate a shower curtain rod therein;
a plurality of windows in said structural member positioned along its length to align with said lighting elements;
a power supply sufficient to energize said lighting elements for a selected duty cycle; and,
a switch to turn said lighting elements on and off.

8. The lighting fixture of claim 7 wherein said lighting elements comprise light-emitting diodes.

9. The lighting fixture of claim 7 wherein said structural member comprises a material selected from the group consisting of: structural polymers and metal alloys.

10. The lighting fixture of claim 7 wherein said power supply comprises a battery pack.

11. The lighting fixture of claim 10 wherein said battery pack is rechargeable.

12. A lighting fixture comprising:
a water-resistant housing, at least a portion of which is transmissive to light, said housing further including a means to hang said housing in a shower facility;
a plurality of lighting elements disposed within said waterproof housing;
a power supply disposed within said waterproof housing for supplying power to said lighting elements; and,
a switch for controlling said power supply.

13. The lighting fixture of claim 12 wherein said housing comprises a generally opaque material having a plurality of light-transmissive windows, and each of said lighting elements is disposed adjacent to a respective window.

14. The lighting fixture of claim 12 wherein said housing comprises a generally light-transmissive material and said lighting elements comprise a strand of lights disposed in a generally random arrangement within said housing.

15. The lighting fixture of claim 12 wherein said lighting elements comprise light-emitting diodes.

16. The lighting fixture of claim 12 wherein said power supply comprises a battery pack.

17. The lighting fixture of claim 16 wherein said battery pack is rechargeable.
